(19) United States
(12) Patent Application Publication
(10) Pub. No.: US 2005/0197424 A1
(43) Pub. Date: Sep. 8, 2005

(54) Ink composition, method of producing ink composition, method of applying liquid using the ink composition and apparatus therefor

(75) Inventors: Ryuji Higashi, Atsugi-shi (JP); Koichi Sato, Atsugi-shi (JP); Ikuo Nakazawa, Zama-shi (JP); Sakae Suda, Sagamihara-shi (JP); Masayuki Ikegami, Atsugi-shi (JP); Keiichiro Tsubaki, Kawasaki-shi (JP); Keiko Yamagishi, Ebina-shi (JP); Tomoya Yamamoto, Fukui-shi (JP)

Correspondence Address: FITZPATRICK CELLA HARPER & SCINTO, 30 ROCKEFELLER PLAZA, NEW YORK, NY, 10112, US

(73) Assignees: Canon Kabushiki Kaisha, Tokyo (JP); Canon Finetech Inc., Ibaraki-ken (JP)

(21) Appl. No.: 11/070,209

(22) Filed: Mar. 3, 2005

(30) Foreign Application Priority Data
Mar. 5, 2004 (JP) 2004-062965

(51) Int. Cl. C03C 17/00; C09D 11/00

(52) U.S. Cl. 523/160; 523/161

(57) ABSTRACT

An ink composition comprising at least a block polymer compound having a polyalkenyl ether main chain, a solvent and a pigment, wherein particles composed of the block polymer compound and the pigment have an average particle size of not more than 80 nm and the particles in the composition have a dispersion index of not more than 0.15.

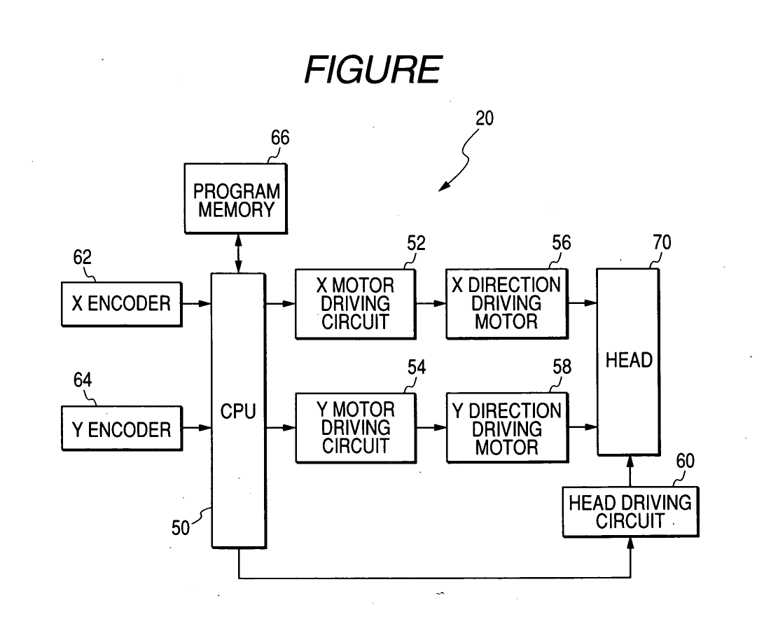

### BACKGROUND OF THE INVENTION

1. Field of the Invention

The present invention relates to an ink composition containing a block polymer, a method of applying liquid and an apparatus for applying liquid using the composition. In particular, the present invention is useful as a composition for image forming materials which can be used for printers or displays, and relates to a method of applying liquid and an apparatus for applying liquid using the composition.

2. Related Background Art

Recently, digital printing technologies represented by ink jet technology have been developing at an incredible speed. In particular, with its characteristics of compact size and low power consumption, ink jet technology using dye ink has not only been developed as a relatively simple printing method but also enabling higher image quality printing due to nozzles becoming finer and improved ink discharge methods, and the image quality has now been almost comparable to that of silver halide photography. However, even in the case of dyes dried on a recording medium, dye ink sometimes causes bleeding when superimposing colors, or a phenomenon of spreading of ink (feathering) along the fiber direction of the recording medium due to a capillary phenomenon may be observed immediately after discharge. For solving these problems, an ink composition containing particles of an average diameter of 100 nm or less which comprise a dye and an aqueous liquid vehicle has been reported (U.S. Pat. No. 5,145,518). However, although bleeding and feathering have been reduced, printed images had poor weatherability and there was a problem of long time keeping of the printed image. As means for solving these problems, use of pigment dispersion ink instead of dye ink has been proposed (DIC technical review, No. 9, 2003, DIC technical review, No. 8, 2002). According to the investigation of the present inventors, while the use of the pigment dispersion ink reduces bleeding and feathering and improves the storing properties of the printed image, other problems arose in some cases, such as storage stability of the ink itself, decreased density of the printed image, increased brightness and reduced color saturation. Thus, pigment ink without bleeding or feathering, excellent in the weatherability and the storage stability of the image and capable of forming clear images is presently demanded in the market.

### SUMMARY OF THE INVENTION

The ink composition provided by the present invention is an ink composition comprising at least a block polymer compound having a polyalkenyl ether main chain, a solvent and a pigment, wherein particles composed of the block polymer compound and the pigment have an average particle size of not more than 80 nm and the particles in the composition have a dispersion index of not more than 0.15.

Another ink composition of the present invention is an ink composition comprising at least a block polymer compound having a polyalkenyl ether main chain, a solvent and a pigment, wherein particles in which the pigment is encapsulated in the block polymer compound have an average particle size of not more than 80 nm and the particles in the composition have a dispersion index of not more than 0.15.

In the present invention, the block polymer compound comprises 3 or more block segments.

Also, the block polymer compound has both a hydrophobic block segment and a hydrophilic block segment.

The method of producing an ink composition of the present invention is a method of producing an ink composition comprising a block polymer compound, a pigment and a solvent, which method comprises a first dispersing step of preparing a first dispersion by dispersing at least a block polymer and a pigment in the solvent, the block polymer having both a hydrophobic block segment and a hydrophilic block segment and also a polyalkenyl ether main chain, and a second dispersing step of preparing a second dispersion by adding water or an aqueous solution to the first dispersion and further dispersing, wherein an average particle size a of the first dispersion and an average particle size b of the second dispersion have a relationship described in the formula (1).
1.0≦a/b≦2.0 (formula 1)

The method of producing an ink composition of the present invention includes a method of producing an ink composition, further comprising a pre-dispersing step of preparing a pre-dispersion by dispersing the pigment in the solvent prior to the first dispersing step, wherein when an average particle size of the pre-dispersion is defined as c, the average particle size b and the average particle size c have a relationship described in the formula (2).
1.0≦c/b≦3.0 (formula 2)

In addition, in the dispersing steps of the present invention, particles may be dispersed by a sand mill dispersion using spherical beads and a dispersion device.

The method of producing an ink composition of the present invention also includes a method of producing an ink composition, wherein when an average particle size of the spherical beads is defined as d, the average particle size b and the average particle size d have a relationship described in the formula 3.
d/2000≦b≦d/500 (formula 3)

The present invention also includes a method of producing an ink composition, wherein the average particle size b and the average particle size d have a relationship described in the formula 4.
d/3000≦b≦d/300 (formula 4)

The present invention also includes a method of producing an ink composition, wherein the spherical beads have an average particle size of 40 to 110 μm and a density of not less than 5.9×10⁻⁶ g/m³.

The present invention also includes a method of producing an ink composition, wherein the sand mill dispersing is conducted at a peripheral speed of not more than 8.0 m/second.

The method of applying ink provided by the present invention comprises a step of applying an ink composition of the present invention on a medium.

The apparatus of applying ink provided by the present invention comprises ink applying means for applying ink on a medium by supplying energy to an ink composition of the present invention and driving means for driving the ink applying means.

According to the present invention, by using an ink composition comprising a polymer dispersion body which is formed by agglomeration of a pigment and a block polymer having a polyalkenyl ether main chain and which contains particles having an average particle size of not more than 80 nm and a dispersion index of not more than 0.15, a pigment ink composition which is excellent in storage stability, free of bleeding or feathering and capable of providing dense and high color saturation printed images excellent in light resistance when printed, a method of producing the composition, a method of applying liquid and an apparatus for applying liquid can be provided.

### BRIEF DESCRIPTION OF THE DRAWING

FIGURE is a diagram illustrating a general mechanism of the image recording apparatus of the present invention.

### DESCRIPTION OF THE PREFERRED EMBODIMENTS

In the following, the present invention is described in detail.

The ink composition of the present invention is an ink composition comprising at least a block polymer compound having a polyalkenyl ether main chain, a solvent and a pigment, wherein particles composed of the block polymer compound and the pigment have an average particle size of not more than 80 nm and the particles in the composition have a dispersion index of not more than 0.15. The ink composition of the present invention also includes an ink composition in which the pigment is encapsulated in the block polymer compound.

In addition, the method of producing an ink composition of the present invention is a method of producing an ink composition comprising a block polymer compound, a pigment and a solvent, which method comprises a first dispersing step of preparing a first dispersion by dispersing, in the solvent, at least a pigment and a block polymer containing both a hydrophobic block segment and a hydrophilic block segment and having a polyalkenyl ether main chain, and a second dispersing step of preparing a second dispersion by adding water or an aqueous solution to the first dispersion and further dispersing, wherein an average particle size a of the first dispersion and an average particle size b of the second dispersion have a relationship described in the formula (1).
1.0≦a/b≦2.0 (formula 1)

In the present invention, the block polymer compound preferably contains not less than 3 block segments, and more preferably is a block polymer compound containing a hydrophobic block segment and a hydrophilic block segment.

The pigment in the present invention can be defined as a water- or oil-insoluble colored substance as opposed to dyes which are water- or oil-soluble colored substance. Specific examples include near infrared reflection materials, oxidation catalysts, deodorization and antibacterial use, heat removal, smoke elimination and demineralization, inhibition of dioxin, insect removal, light scattering agent for backlight of liquid crystal panels, fluorescent materials and photoconductive materials, and in addition, applications to cosmetics such as ultraviolet protection and adsorption effects, coatings, color materials such as toners and ink are also available. In the present invention, color materials are preferably used, but the present invention is not limited to these.

The term “encapsulated” in the present invention refers to formation of micelles or reversed micelles of the block polymer compound so as to enclose the pigment, which phenomenon can be confirmed by an electron microscope.

The block polymer compound in the present invention means a polymer compound comprised of not less than two different block segments, and the number of the block segments is preferably not less than 3 in view of properties. Furthermore, for encapsulating functional substances, the block polymer compound preferably contains both a hydrophobic block segment and a hydrophilic block segment. The hydrophobic block segment in the present invention means a block segment difficult to be bonded with water molecules, while the hydrophilic block segment means a block segment easy to be bonded with water molecules. Referring to specific constructions of the block segments, the hydrophobic segment preferably has a construction in which an aromatic hydrocarbon is contained in a side chain, and the hydrophilic segment preferably has a construction in which an alkylene oxide ether chain or a carboxylic acid or a carboxylic acid anion is contained in a side chain.

Specific examples of the repeat unit of the hydrophobic segment in the present invention are described below, but the present invention is not limited to these. 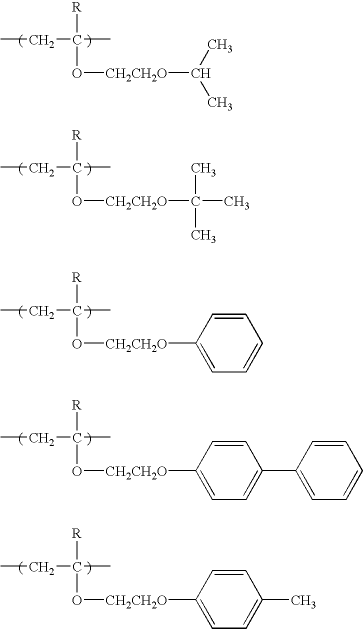
(wherein R is selected from alkyl and hydrogen atom.)

Specific examples of the repeat unit of the hydrophilic segment in the present invention are described below, but the present invention is not limited to these.

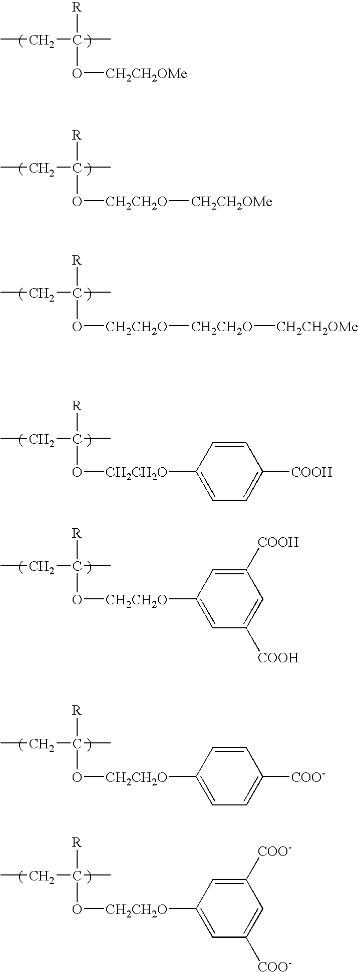

When the hydrophilic segment is an anionic segment, the counter cation may be an atom or a compound, specifically a lithium cation, a sodium cation, a potassium cation or a calcium cation, but the counter cation in the present invention is not limited to particular atoms or compounds.

As the block polymer in the present invention, compounds having a repeat unit represented by the following general formula can be exemplified. 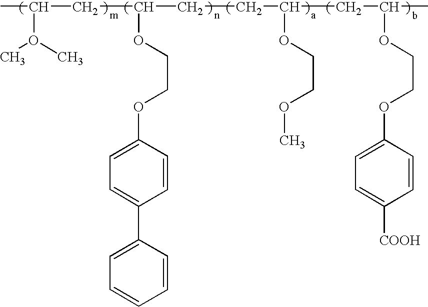
(wherein m, n, a and b mean any integer).

As the polymerization method of the block polymer used in the present invention, a polymerization method capable of forming not less than two block segments may be employed. However, to set the dispersion index of the block polymer dispersion body to not more than 0.15, preferably not more than 0.10, a block polymer synthesized by a living polymerization method is preferably used. Next, a living polymerization method of a block polymer having a polyalkenyl ether structure preferably produced in the present invention is explained. Some methods of synthesizing a polymer having a polyvinyl ether structure have been reported (Japanese Patent Application Laid-Open No. H11-080221), and the methods by Aoshima et al., (Polymer Bulletin, 15, 417 to 423 (1986), Japanese Patent Application Laid-Open No. H11-322942) are typical examples. Synthesis of polymer compounds according to the methods by Aoshima et al. affords various polymers such as homopolymers, copolymers of two or more monomer components, block polymers and graft polymers with accurately controlling the length (molecular weight).

In the block polymer in the present invention, the number of repeat units of each block segment is preferably not less than 3 to not more than 10,000. A number average molecular weight (Mn) of not less than 1,000 to not more than 1,000,000 is preferable because a substance which exhibits a pre-determined function can be dispersed in a solvent well.

The content of the block polymer having a polyalkenyl ether main chain contained in the ink composition of the present invention is 0.1 to 50% by weight, preferably 1 to 20% by weight based on the total weight of the ink composition. A content of not less than 0.1% by weight affords preferable dispersion stability while a content of not more than 50% by weight affords a preferable viscosity.

A composition using a coloring material as a pigment contained in the composition of the present invention can be used as a preferable composition. In the following, specific examples of the organic pigment and the inorganic pigment used for the composition are described. The pigment used for ink is preferably a black pigment and three primary color pigments of cyan, magenta and yellow. Pigments of a color other than those listed above, colorless, white or pale color pigments, pigments having an absorption spectrum at an infrared or ultraviolet wavelength region and metalescent pigments may also be used. In the present invention, commercially available pigments or newly synthesized pigments may also be used.

In the following, commercially available pigments of black, cyan, magenta and yellow are listed.

Examples of the black pigment include Raven 1060, Raven 1080, Raven 1170, Raven 1200, Raven 1250, Raven 1255, Raven 1500, Raven 2000, Raven 3500, Raven 5250, Raven 5750, Raven 7000, Raven 5000 ULTRA II, Raven 1190 ULTRA II (available from Colombian Carbon), Black Pearls L, MOGUL-L, Regal 400R, Regal 660R, Regal 330R, Monarch 800, Monarch 880, Monarch 900, Monarch 1000, Monarch 1300, Monarch 1400 (available from Cabot), Color Black FW1, Color Black FW2, Color Black FW200, Color Black 18, Color Black S160, Color Black S170, Special Black 4, Special Black 4A, Special Black 6, Printex 35, Printex U, Printex 140U, Printex V, Printex 140V (available from Degussa), and No. 25, No. 33, No. 40, No. 47, No. 52, No. 900, No. 2300, MCF-88, MA600, MA7, MA8, MA 100 (available from Mitsubishi Chemical), but not limited to these.

Examples of the cyan pigment include C. I. Pigment Blue-1, C. I. Pigment Blue-2, C. I. Pigment Blue-3, C. I. Pigment Blue-15, C. I. Pigment Blue-15:2, C. I. Pigment Blue-15:3, C. I. Pigment Blue-15:4, C. I. Pigment Blue-16, C. I. Pigment Blue-22, C. I. Pigment Blue-207, but not limited to these.

Examples of the magenta pigment include C. I. Pigment Red-5, C. I. Pigment Red-7, C. I. Pigment Red-12, C. I. Pigment Red-48, C. I. Pigment Red-48:1, C. I. Pigment Red-57, C. I. Pigment Red-112, C. I. Pigment Red-122, C. I. Pigment Red-123, C. I. Pigment Red-146, C. I. Pigment Red-168, C. I. Pigment Red-184, C. I. Pigment Red-202 and C. I. Pigment Red-207, but not limited to these.

Examples of the yellow pigment include C. I. Pigment Yellow-12, C. I. Pigment Yellow-13, C. I. Pigment Yellow-14, C. I. Pigment Yellow-16, C. I. Pigment Yellow-17, C. I. Pigment Yellow-74, C. I. Pigment Yellow-83, C. I. Pigment Yellow-93, C. I. Pigment Yellow-95, C. I. Pigment Yellow-97, C. I. Pigment Yellow-98, C. I. Pigment Yellow-114, C. I. Pigment Yellow-128, C. I. Pigment Yellow-129, C. I. Pigment Yellow-151 and C. I. Pigment Yellow-154, but not limited to these.

The solvent contained in the composition of the present invention means a medium capable of dissolving, suspending or dispersing the components contained in the composition. In the present invention, the solvent includes organic solvents such as linear, branched or cyclic aliphatic hydrocarbons, aromatic hydrocarbons and heteroaromatic hydrocarbons, aqueous solvents and water. In particular, in the composition of the present invention, water and aqueous solvents are preferably used. Examples of the aqueous solvent include polyhydric alcohols such as ethylene glycol, diethylene glycol, triethylene glycol, polyethylene glycol, propylene glycol, polypropylene glycol and glycerol; polyhydric alcohol ethers such as ethylene glycol monomethyl ether, ethylene glycol monoethyl ether, ethylene glycol monobutyl ether, diethylene glycol monoethyl ether and diethylene glycol monobutyl ether; and solvents containing nitrogen such as N-methyl-2-pyrrolidone, substituted pyrrolidone and triethanolamine. In the case of use as ink, monohydric alcohols such as methanol, ethanol and isopropyl alcohol may be used for drying the ink on paper fast, but the solvent used in the present invention is not limited to these.

Examples of additives which may be contained in the composition of the present invention include cross-linking agents and acid generating agents activated by applying heat or electromagnetic waves.

Other additives that can be added to the composition of the present invention include pH adjusters for stabilizing ink and achieving stability in the ink pipe in the recording apparatus, penetrants which facilitate penetration of the ink into the recording medium and speed up apparent drying, antifungal agents which prevent fungus from growing in the ink, chelating agents which block metal ions in the ink to prevent metal from precipitating at nozzles or prevent precipitation of insoluble substances in the ink, defoaming agents which prevent generation of foam during circulation, transfer or production of recording fluid, antioxidants, viscosity controlling agents, conductive agents and ultraviolet ray absorbers.

As the polymerization method of the block polymer compound used in the present invention, a polymerization method capable of forming not less than two block segments may be employed. However, to set the dispersion index of the block polymer dispersion body to not more than 0.15, preferably not more than 0.10, a block polymer compound synthesized by a living polymerization method is preferably used. Next, a living polymerization method of a block polymer compound having a polyalkenyl ether structure preferably produced in the present invention is explained. A number of methods have been reported for the synthesis of a polymer compound having a polyvinyl ether structure (Japanese Patent Application Laid-Open No. H11-080221), and the methods by Aoshima et al., (Polymer Bulletin, 15, 417 to 423 (1986), Japanese Patent Application Laid-Open Nos. H11-322942 and H11-322866) are typical examples. Synthesis of polymer compounds according to the methods by Aoshima et al. affords various polymers such as homopolymers, copolymers of two or more monomer components, block polymer compounds and graft polymer compounds with accurately controlling the length (molecular weight).

In addition, for the average particle size and the dispersion index of the above-mentioned particles in the present invention, values measured at 20° C. at a polymer concentration of 0.01 wt. % using dynamic light scattering (DLS) are employed. However, any other measuring methods such as a laser diffraction method, a laser Doppler method, a centrifugal sedimentation method, a field-flow fractionation method and an electric sensing zone technique may be employed as long as the values are corrected to those to be measured by a DLS method. In the present invention, the Stokes' radius is employed for defining an average particle size (diameter). As the index of the uniformity of the particle size, the dispersion index (μ/G², μ: quadratic coefficient of cumulant expansion, G: attenuation constant) presented by Gulari et al is commonly used (The Journal of Chemical Physics, vol. 70, p. 3965, 1979). The index is also calculated by a dynamic light scattering method.

The method of producing an ink composition of the present invention satisfies the above-described relationship of the average particle sizes shown in the formula 1. That is, the method of producing an ink composition of the present invention is a method of producing an ink composition comprising a block polymer compound, a pigment and a solvent, which method comprises a first dispersing step of preparing a first dispersion by dispersing, in the solvent, at least a pigment and a block polymer containing both a hydrophobic block segment and a hydrophilic block segment and having a polyalkenyl ether main chain, and a second dispersing step of preparing a second dispersion by adding water or an aqueous solution to the first dispersion and further dispersing, wherein an average particle size a of the first dispersion and an average particle size b of the second dispersion have a relationship described in the formula (1).
1.0≧a/b≧2.0 (formula 1)

The method of producing an ink composition of the present invention includes a method of producing an ink composition, further comprising a pre-dispersing step of preparing a pre-dispersion by dispersing the pigment in the solvent prior to the first dispersing step, wherein when an average particle size of the pre-dispersion is defined as c, the average particle size b and the average particle size c have a relationship described in the formula (2).
1.0≦c/b≦3.0 (formula 2)

In addition, in the present invention, sand mill dispersing using spherical beads and a disperser may be conducted in the dispersing step.

The method of producing an ink composition of the present invention also includes a method of producing an ink composition, wherein when an average particle size of the spherical beads is defined as d, the average particle size b and the average particle size d have a relationship described in the formula 3.
d/2000≦b≦d/500 (formula 3)

The present invention also includes a method of producing an ink composition, wherein the average particle size b and the average particle size d have a relationship described in the formula 4.
d/3000≦b≦d/300 (formula 4)

Here, although the details are unknown, a/b of the average particle size a of the first dispersion and the average particle size b of the second dispersion needs to be not more than 2.0, more preferably not more than 1.5 to obtain a good printing density. In addition, c/b of the average particle size c of the pre-dispersion and the average particle size b of the second dispersion is preferably not more than 3.0, more preferably not more than 1.5 to obtain a good printing density.

Specific examples of the organic solvent used in the present invention include methanol, ethanol, n-propanol, diethylether, tetrahydrofuran, dioxane, toluene and xylene, but the present invention is not limited to these. Regarding the composition of a mixed solvent, a water content of not less than 50 wt. % is preferable for ink for inkjet, and examples of the organic solvent include methanol, ethanol, n-propanol, diethylether, tetrahydrofuran, dioxane, toluene and xylene, but the present invention is not limited to these. Water may be dissolved or dispersed in the organic solvent or emulsified with the solvent.

Specific examples of the disperser used for dispersing the composition for ink jet of the present invention include an ultrasonic homogenizer, a jet mill, a high pressure homogenizer, a colloid mill, a ball mill, a sand mill and a paint shaker, which may be used alone or in a combination. As to the composition of the ink in the present invention, however, a sufficient average particle size cannot be obtained when the dispersion force is too low. On the other hand, when the dispersion force is too high, over-dispersion may be caused and not only coarse particles are formed due to re-agglomeration, but also the block polymer dispersion body encapsulating the pigment may collapse. For such reason, to obtain the intended average particle size and the dispersion index, it is preferable to conduct dispersing by using a sand mill disperser which can achieve the intended dispersion force. The dispersion force in the present invention refers to mechanical energy supplied to a dispersion body. In the pre-dispersing step, dispersion is preferably conducted with a dispersion force lower than that in the dispersing step or the phase inversion step in view of the properties of the ink. Specifically, an ultrasonic homogenizer, a jet mill, a high pressure homogenizer, a colloid mill, a ball mill, a sand mill and a paint shaker are included, and these may be used alone or in a combination. In some cases, pre-dispersion may be conducted without using a dispersing agent. The dispersing agent used in the sand mill dispersing is preferably in the form of spherical beads from the aspects of dispersion stability and inhibition of generation of coarse particles. In addition, although the details are unknown, the spherical beads preferably have an average particle size of 40 to 110 μm and a density of not less than 5.9×10⁻⁶ g/m³ to obtain a good printing density. Specific examples of the dispersing agent include glass beads, titania beads, zirconia beads, alumina beads, flint and iron balls, but the dispersing agent used in the present invention is not limited to these. In addition, while successful fine dispersion is generally expected when the dispersion force is increased by the increase of the rotation speed of a sand mill disperser, the average particle size in the present invention tends to grow instead when the peripheral speed is increased. Thus, in order to obtain an intended polymer dispersion body, dispersion is preferably carried out at not more than 8.0 m/second. The reason may be because over-dispersion is caused due to an excessively increased peripheral speed, and this results in re-agglomeration of over-dispersed pigment particles. However, the detail mechanism is presently unknown.

The method of applying liquid of the present invention is now described.

[Method of Applying Liquid]

A preferable embodiment of using the ink composition of the present invention is a method of applying liquid in which recording is conducted by discharging ink on a recording medium through an ink discharge port. In particular, the method is preferably used as various image forming methods such as a pattern forming method for forming pre-determined patterns on a recording medium, printing methods for forming images and/or text on a recording medium, an ink jet method and an electrophotographic method, and the method is particularly preferably used for the ink jet method.

The ink jet method may be known methods such as piezo ink jet system using a piezoelectric element or a Bubble Jet® system which conduct recording by bubbling with applying thermal energy. In addition, a continuous type or an on-demand type may also be used. The composition of the present invention can be used in a recording system in which ink is applied on an intermediate transfer member and then transferred to a final recording medium such as paper.

Next, the apparatus for applying liquid of the present invention is described.

[Apparatus for Applying Liquid]

The ink composition of the present invention can be used in an apparatus for applying liquid employing the above-described method of applying liquid, in a pattern forming apparatus employing a pattern forming method for forming pre-determined patterns on a recording medium, and in image forming apparatuses employing various image forming methods such as methods for forming images and/or text on a recording medium, an ink jet method and an electrophotographic method, and the apparatus is particularly preferably used for the ink jet recording apparatus.

The ink jet recording apparatus using the ink for ink jet of the present invention includes ink jet recording apparatuses such as piezo ink jet system using a piezoelectric element and a Bubble Jet® system which conduct recording by bubbling with applying thermal energy.

FIGURE is a schematic diagram illustrating the function of an ink jet recording apparatus. Reference numeral 50 denotes a central processing unit (CPU) of the ink jet recording apparatus 20. The program for controlling the CPU 50 may be stored in program memory 66 or in storing means such as EEPROM (not shown) as a firmware. The program memory 66 of the ink jet recording apparatus receives recording data from recording data formation means (unrepresented, computers etc.). The recording data may be information such as an image or text to be recorded as it is, or a compressed or coded form thereof. When processing the compressed or coded information, information of image or text to be recorded can be obtained by conducting decompression or extraction in the CPU 50. By providing an X encoder 62 (e.g., for X direction or main scanning direction) and a Y encoder 64 (e.g., for Y direction or sub scanning direction), the position of the head relative to the recording medium can be communicated to the CPU 50.

The CPU 50 sends a signal for recording an image to an X motor drive circuit 52, a Y motor drive circuit 54 and a head drive circuit 60 based on the information in the program memory 66, the X encoder 62 and the Y encoder 64. The X motor drive circuit 52 activates an X direction drive motor 56 and the Y motor drive circuit 54 activates a Y direction drive motor 58 to move a head 70 relative to the recording medium to a recording position. The head drive circuit 60 sends a signal for discharging each composition (Y, M, C, K) or a stimulation giving substance which serves as stimulation at the time when the head 70 have moved to the recording position to conduct recording. The head 70 may be for discharging a single color composition or several kinds of compositions, or may also have a mechanism of discharging a stimulation giving substance which serves as stimulation.

### EXAMPLES

Hereinafter, the present invention is explained in detail by means of Examples, but the present invention is not limited to these Examples. In the following Example, production of a block polymer compound having a polyalkenyl ether structure used in the present invention will be described. “%” and “part(s)” in the following mean “% by weight” and “parts by weight”, respectively.

### Synthesis Example

Synthesis of tri-block polymer compound of isobutyl vinyl ether and CH₂═CHOCH₂CH₂OPhPh: (IBVE-r-BPhOVE: block A), 2-methoxyethylvinyl ether (MOVE: block B) and 4-(2-vinyloxy)benzoic acid (BBVE: block C), poly[(IBVE-r-BPhOVE)-b-(MOVE)-b-(EBVE)] (symbol r indicates a random polymer and symbol b indicates a block polymer compound)

The inside air of a glass container equipped with a three-way stopcock was replaced with nitrogen, and the glass container was heated to 250° C. under a nitrogen stream to remove adsorbed water. The system was cooled to room temperature, and 6 mmoles (millimoles) of IBVE, 6 mmoles of BPhOVE, 16 mmoles of ethyl acetate, 0.1 mmole of 1-isobutoxyethyl acetate and 11 ml of toluene were added, and the system was cooled with stirring. When the temperature within the system reached 0° C., 0.2 mmole of ethyl aluminum sesquichloride (an equimolar mixture of diethyl aluminum chloride and ethyl aluminum dichloride) was added to initiate polymerization. The molecular weight was monitored with time using molecular sieve column chromatography (GPC) to confirm the completion of the polymerization of the block A.

Subsequently, 12 mmoles of MOVE was added as a block B component, and the completion of the polymerization of the block B was confirmed by monitoring using GPC.

After the completion of the polymerization of the block B, a solution of EBVE (3.6 mmoles) in toluene was added and after 24 hours, the polymerization reaction was stopped by adding 0.3% by weight aqueous ammonia/methanol solution to obtain a solution of block polymer precursor in toluene. After washing the toluene solution with 0.6 mmole/l dilute hydrochloric acid and purified water, the resultant was purified by removing toluene by using an evaporator and precipitating with methanol to give a block polymer precursor. Then, the block polymer precursor was dissolved in dimethylformamide and 18.0 mmoles of sodium hydroxide was added thereto, and the mixture was stirred at room temperature for 72 hours for the deprotection of ethylbenzoic acid of the block C. After the completion of the reaction, dimethylformamide was removed by using an evaporator and the obtained solid was dissolved in chloroform, and the chloroform solution was washed with 0.6 mole/l dilute hydrochloric acid and purified water. After washing, chloroform was removed by using an evaporator to obtain the objective tri-block polymer compound. The compound was identified by ¹H-NMR and GPC. Mn was 23000 and Mw/Mn was 1.44. The polymerization ratio was A:B:C=100:100:30 and the polymerization ratio of the two kinds of monomers within the block A was 1:1.

### Example 1

6 parts of the tri-block polymer compound obtained in Synthesis Example was dissolved in 94 parts of dimethylformamide to give a tri-block polymer solution. After mixing and introducing 100 parts of the tri-block polymer solution, 6 parts of C.I. Pigment Blue-15:3 and 400 parts of zirconia beads having a diameter (d) of 0.05 mm and a density of 6.03×10⁻⁶ g/m, the mixture was dispersed using a sand mill disperser (made by KOTOBUKI ENGINEERING & MANUFACTURING CO., LTD., Sand Mill UAM-015) at a peripheral speed of 6.0 m/second for 10 minutes. According to this, a dispersion body having an average particle size (a) of 101 nm and a dispersion index of 0.101 was obtained. Furthermore, 150 parts of a 0.01 mole/l potassium hydroxide aqueous solution was added and the mixture was dispersed at a peripheral speed of 6.0 m/second for 30 minutes. After removing zirconia beads by using a centrifuge (peripheral speed: 6.0 m/second), the mixture was filtrated under pressure through a 1 μm filter, whereby ink for ink jet recording having an average particle size (b) of 70 nm and a dispersion index of 0.087, in which C.I. Pigment Blue-15:3 was encapsulated in the block polymer dispersion body, was prepared. The average particle size was measured by DLS-7000 (made by Otsuka Electronics Co., Ltd.) and encapsulation of C.I. Pigment Blue-15:3 by the polymer dispersion body was confirmed by an electron microscope. In this Example, a/b was 101/70=1.4.

### Example 2

In the same manner as in Example 1 except that the rotation speed of the bead mill was set to 8.0 m/second, ink for ink jet having an average particle size of 76 nm and a dispersion index of 0.091 was prepared.

### Example 3

3 parts of the tri-block polymer compound obtained in Synthesis Example 1 was dissolved in 97 parts of dimethylformamide to give a tri-block polymer solution. After introducing to a vessel 100 parts of the binding resin solution, 6 parts of C.I. Pigment Blue-15:3, 150 parts of a 0.01 mole/l potassium hydroxide aqueous solution and 250 parts of zirconia beads having a diameter of 0.05 mm and a density of 6.03×10⁻⁶ g/m³, the mixture was dispersed using a sand mill disperser (made by KOTOBUKI ENGINEERING & MANUFACTURING CO., LTD., Sand Mill UAM-015) at a peripheral speed of 6.0 m/second for 30 minutes to obtain a dispersion body having an average particle size. (a) of 105 nm and a dispersion index of 0.092. After removing zirconia beads by using a centrifuge at a peripheral speed of 6.0 m/second, the mixture was filtrated under pressure through a 1 μm filter, whereby ink for ink jet recording having an average particle size (b) of 70 nm and a dispersion index of 0.098 was prepared.

### Example 4

Using a sand mill disperser (made by KOTOBUKI ENGINEERING & MANUFACTURING CO., LTD., Sand Mill UAM-015) the pre-dispersing step and the subsequent dispersing step were conducted. 6 parts of C.I. Pigment Blue-15:3 and 400 parts of zirconia beads having a diameter (d) of 0.05 mm and a density of 6.03×10⁻⁶ g/m were mixed to 94 parts of dimethylformamide, and pre-dispersing was conducted at a peripheral speed of 6.0 m/second for 15 minutes to give a pre-dispersion body having an average particle size (c) of 150 nm and a dispersion index of 0.110. Thereto was added 6 parts of the tri-block polymer compound obtained in Synthesis Example 1 and the mixture was dispersed at a peripheral speed of 6.0 m/second for 10 minutes to give a dispersion body having an average particle size (b) of 90 nm and a dispersion index of 0.102. Furthermore, 150 parts of a 0.01 mole/l potassium hydroxide aqueous solution was added and the mixture was dispersed at a peripheral speed of 6.0 m/second for 30 minutes. After removing zirconia beads by using a centrifuge (peripheral speed: 6.0 m/second), the mixture was filtrated under pressure through a 1 μm filter, whereby ink for ink jet recording having an average particle size (a) of 68 nm and a dispersion index of 0.089, in which C.I. Pigment Blue-15:3 was encapsulated in the block polymer dispersion body, was prepared. The average particle size was measured by DLS-7000 (made by Otsuka Electronics Co., Ltd.) and encapsulation of C.I. Pigment Blue-15:3 by the polymer dispersion body was confirmed by an electron microscope.

### Example 5

In the same manner as in Example 4 except that carbon black (MOGUL L®, available from Cabot Corporation) was used instead of C.I. Pigment Blue-15:3, ink for ink jet having an average particle size of 140 nm and a dispersion index of 0.110 was prepared.

### Comparative Example 1

In the same manner as in Example 1 except that the tri-block polymer compound was changed to a styrene-acrylic acid-ethyl acrylate copolymer (molecular weight about 10000), ink for ink jet having an average particle size of 150 nm and a dispersion index of 0.252 was prepared.

### Comparative Example 2

In the same manner as in Comparative Example 1 except that glass beads having a density of 2.5×10⁻⁶ g/m³ and an average particle size of 0.80 mm was used instead of zirconia beads, ink for ink jet having an average particle size of 220 nm and a dispersion index of 0.234 was prepared.

### Comparative Example 3

In the same manner as in Example 1 except that dispersing by the sand mill disperser in Example 1 was conducted not for 10 minutes but for 30 seconds and then not for 30 minutes but for 10 minutes, ink for ink jet recording was prepared. Here, the dispersion obtained in the first dispersing step had an average particle size (a) of 400 nm and the dispersion obtained in the second dispersing step had an average particle size (b) of 170 nm, and the final ink composition had a dispersion index of 0.167.

### Comparative Example 4

In the same manner as in Example 1 except that dispersing by the sand mill disperser in Example 1 was conducted using zirconia beads having a diameter of 1.0 mm for a dispersing time of 1 minute instead of 10 minutes, ink for ink jet recording was prepared. Here, the dispersion obtained in the first dispersing step had an average particle size (a) of 920 nm and the dispersion obtained in the second dispersing step had an average particle size (b) of 400 nm, and the final ink composition had a dispersion index of 0.181.

The method of evaluation of ink for ink jet prepared in Examples 1 to 3 and Comparative Examples 1, 2 and 3 are described in the following. The storage stability of liquid is an evaluation of sedimentation after storing the liquid for 30 days at 30° C. In the table, the evaluation criteria of the storage stability of liquid are as follows (Table 1).
A: no sedimentation, no change in average particle size or particle size distribution
B: no sedimentation, but particle size increased and particle size distribution broadened
C: sedimentation occurred

For the evaluation of images, the composition of Examples 1 to 4 and Comparative Examples 1, 2 and 3 was each filled in a print head of an ink jet printer (BJF800, made by Cannon Inc.) and solid images-were printed on a plain paper (PB PAPER, available from Cannon Inc.). L*, a* and b* values were measured by Spectrophotometer SQ2000 (made by Nippondenso Co., Ltd.) to determine the brightness and the color saturation, and the reflection density in the cyan region was measured by using RD-19I (made by GretagMacbeth AG) (Table 1).

TABLE 1

| | Evaluation of the color of image | | | Storage |
|---|---|---|---|---|
| | | Color | Reflection | stability |
| | Brightness | saturation | density | of liquid |
| Example 1 | 65.3 | 33.5 | 0.77 | A |
| Example 2 | 66.2 | 32.6 | 0.72 | A |
| Example 3 | 66.5 | 32.3 | 0.74 | A |
| Example 4 | 62.3 | 32.7 | 0.77 | B |
| Comparative | 70.2 | 27.2 | 0.55 | B |
| Example 1 | | | | |
| Comparative | 71.3 | 26.3 | 0.50 | C |
| Example 2 | | | | |
| Comparative | 69.2 | 29.0 | 0.60 | A |
| Example 3 | | | | |

The brightness is indicated by an L* value and the color saturation is indicated by scalar quantity (a^{*2}+b^{*2})^{1/2} of (a*, b*).

This application claims priority from Japanese Patent Application No. 2004-062965 filed Mar. 5, 2004, which is hereby incorporated by reference herein.

1. An ink composition comprising at least a block polymer compound having a polyalkenyl ether main chain, a solvent and a pigment, wherein particles composed of the block polymer compound and the pigment have an average particle size of not more than 80 nm and the particles in the composition have a dispersion index of not more than 0.15.

2. An ink composition comprising at least a block polymer compound having a polyalkenyl ether main chain, a solvent and a pigment, wherein particles in which the pigment is encapsulated in the block polymer compound have an average particle size of not more than 80 nm and the particles in the composition have a dispersion index of not more than 0.15.

3. The ink composition according to claim 1 or 2, wherein the block polymer compound has 3 or more block segments.

4. The ink composition according to claim 1 or 2, wherein the block polymer compound has both a hydrophobic block segment and a hydrophilic block segment.

5. A method of producing an ink composition comprising a block polymer compound, a pigment and a solvent, which method comprises:
a first dispersing step of preparing a first dispersion by dispersing at least a block polymer and a pigment in the solvent, the block polymer containing both a hydrophobic block segment and a hydrophilic block segment and having a polyalkenyl ether main chain; and
a second dispersing step of preparing a second dispersion by adding water or an aqueous solution to the first dispersion and further dispersing the mixture,
wherein an average particle size a for the first dispersion and an average particle size b for the second dispersion have a relationship described in the formula (1),
1.0≦a/b≦2.0 (formula 1).

6. The method of producing an ink composition according to claim 5, further comprising a pre-dispersing step of preparing a pre-dispersion by dispersing the pigment in the solvent prior to the first dispersing step,
wherein when an average particle size of the pre-dispersion is defined as c, the average particle size b and the average particle size c have a relationship described in the formula (2),
1.0≦c/b≦3.0 (formula 2).

7. The method of producing an ink composition according to claim 5 or 6, wherein the dispersing steps comprise a sand mill dispersion using spherical beads and a dispersion device.

8. The method of producing an ink composition according to claim 7, wherein when an average particle size of the spherical beads is defined as d, the average particle size b and the average particle size d have a relationship described in the formula 3,
d/2000≦b≦d/500 (formula 3).

9. The method of producing an ink composition according to claim 8, wherein the average particle size b and the average particle size d have a relationship described in the formula 4,
d/3000≦b≦d/300 (formula 4).

10. The method of producing an ink composition according to claim 7, wherein the spherical beads have an average particle size of 40 to 110 μm and a density of not less than 5.9×10⁻⁶ g/m³.

11. The method of producing an ink composition according to claim 7, wherein the sand mill is operated for dispersion at a peripheral speed of not more than 8.0 m/second.

12. A method of applying ink, which comprises a step of applying an ink composition according to claim 1 or 2 on a medium.

13. An apparatus for applying ink, which comprises ink applying means for applying ink on a medium by supplying energy to an ink composition according to claim 1 or 2 and driving means for driving the ink applying means.
